(19) United States
(12) Patent Application Publication
(10) Pub. No.: US 2019/0238022 A1
(43) Pub. Date: Aug. 1, 2019

(54) STEPPED STATOR FOR AN ELECTRIC MOTOR

(71) Applicant: MILWAUKEE ELECTRIC TOOL CORPORATION, Brookfield, WI (US)

(72) Inventors: Russell M. Rapant, Menomonee Falls, WI (US); Brian Trump, Germantown, WI (US); Jeffrey C. Hessenberger, Neosho, WI (US)

(21) Appl. No.: 16/258,745

(22) Filed: Jan. 28, 2019

Related U.S. Application Data
(60) Provisional application No. 62/622,349, filed on Jan. 26, 2018.

(51) Int. Cl. H02K 3/52; H02K 15/00; H02K 16/00; H02K 21/00

(52) U.S. Cl. CPC H02K 3/522; H02K 21/00; H02K 16/00; H02K 15/00

(57) ABSTRACT

An electric motor includes a stator including an annular stator core and an end cap coupled to an axial end of the stator core. The stator core and the end cap together define a body portion and a plurality of teeth projecting inwardly from the body portion. Each tooth includes a tooth crown portion at a radially distal end and a tooth body portion extending between the body portion and the crown portion. Steps are formed on at least one tooth body portion at the axial end of the stator core.

### CROSS-REFERENCE TO RELATED APPLICATIONS

This application claims priority to co-pending U.S. Provisional Patent Application No. 62/622,349, filed on Jan. 26, 2018, the entire contents of which is incorporated herein by reference.

### FIELD OF THE INVENTION

The present invention relates to electric motors, and more specifically, to stators for electric motors having stepped surfaces at an axial end.

### BACKGROUND OF THE INVENTION

Electric motors can include windings wrapped about teeth formed on a stator. The windings have a tendency to bow outward about a center portion of the teeth, increasing the length of wire required to form the windings.

### SUMMARY OF THE INVENTION

In one construction, an electric motor includes a stator including a stator core and an insulative member coupled to the stator core. The stator core and the insulative member cooperate to define a body portion and a plurality of teeth projecting radially from the body portion. Each tooth includes a tooth crown portion at a radially distal end, and a tooth body portion extending between the body portion and the crown portion. The stator core includes a first core portion having first tooth body portions that partially define the tooth body portions. The stator core also includes a second core portion stacked against the first core portion at an axial end of the stator core, the second core portion having second tooth body portions that partially define the tooth body portions. The first tooth body portion of at least one tooth body portion has a first width, and the second tooth body portion of the at least one tooth body portion has a second width that is less than the first width.

In another construction, an electric motor includes a stator including an annular stator core and an insulative member coupled to the stator core. The stator core and the insulative member together define a body portion and a plurality of teeth projecting radially from the body portion. Each tooth includes a tooth crown portion at a radially distal end and a tooth body portion extending between the body portion and the crown portion. Steps are formed on at least one tooth body portion at an axial end of the stator core.

In another construction, an electric motor includes a stator including an annular stator core and an insulative member coupled to the stator core. The stator includes a body portion and a plurality of teeth projecting inwardly from the body portion. Each tooth includes a tooth crown portion at a radially distal end and a tooth body portion extending between the body portion and the crown portion. The stator core includes core tooth body portions, and the insulative member includes end cap tooth body portions contacting the core tooth body portions. The end cap tooth body portions include end cap inner surfaces that mate with respective core tooth body portions, and end cap outer surfaces located opposite the end cap inner surfaces. The end cap outer surface of at least one end cap tooth body portion comprises a curved surface having a constant radius of curvature.

Other aspects of the application will become apparent by consideration of the detailed description and accompanying drawings.

### BRIEF DESCRIPTION OF THE DRAWINGS

FIG. 1 is an end view of a prior art stator having a known winding configuration.

FIG. 2 is a cross sectional view of the prior art stator of FIG. 1 taken along line 2-2 in FIG. 1, illustrating a core tooth portion sandwiched between end cap tooth portions.

FIG. 3 is a detail view of the stator of FIG. 1 illustrating a substantially flat core tooth outer surface that mates with a substantially flat end cap tooth inner surface.

FIG. 4 is an end view of a stator for an electric motor according to one embodiment of the invention.

FIG. 5 is a perspective view of the stator of FIG. 4.

FIG. 6 is an exploded perspective view of the stator of FIG. 4.

FIG. 7 is and end view of a stator core of the stator of FIG. 4.

FIG. 8 is a detail view of a core tooth portion of the stator of FIG. 4.

FIG. 9 is a is a cross sectional view of the stator of FIG. 4 taken along line 9-9 in FIG. 4, illustrating a core tooth body portion sandwiched between end cap tooth body portions.

FIG. 10 is a detail view of the stator of FIG. 4 illustrating a stepped core outer surface that mates with a stepped end cap inner surface.

FIG. 11 is an end view of a first lamination of a first core portion of the stator of FIG. 4.

FIG. 12 is an end view of a second lamination of a second core portion of the stator of FIG. 4.

FIG. 13 is an end view of a third lamination of a third core portion of the stator of FIG. 4.

FIG. 14 is a cross sectional view of the prior art stator of FIG. 1 taken along line 2-2 in FIG. 1, schematically illustrating wires forming coils wound about the end cap tooth portions and the core tooth portion.

FIG. 15 is a cross sectional view of the stator of FIG. 4 taken along line 9-9 in FIG. 4, schematically illustrating wires forming coils would about the end cap tooth portions and the core tooth portion.

FIG. 16 is an end view of a stator for an electric motor according to another embodiment of the invention.

FIG. 17 is a perspective view of the stator of FIG. 16.

FIG. 18 is a cross sectional view of the stator of FIG. 16 taken along line 18-18 in FIG. 16, illustrating a core tooth body portion sandwiched between end cap tooth body portions.

FIG. 19 is a detail view of the stator of FIG. 16 illustrating a stepped core outer surface that mates with a stepped end cap inner surface.

FIG. 20 is a perspective view of a stator core for an electric motor according to another embodiment of the invention.

FIG. 21 is an end view of the stator core of FIG. 20.

FIG. 22 is a cross sectional view of the stator core of FIG. 20 taken along line 22-22 in FIG. 20, illustrating a core tooth body portion.

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

### DETAILED DESCRIPTION OF THE DRAWINGS

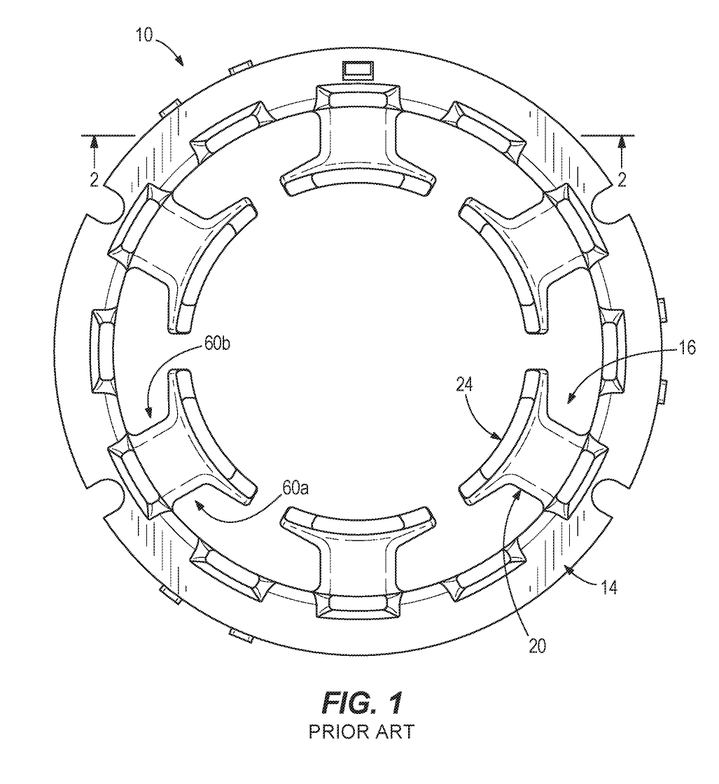

FIG. 1 illustrates an end view of a prior art stator 10 for an electric motor that is operable to produce an electric field. The stator 10 includes a substantially cylindrical stator body 14 and inwardly protruding teeth 16 extending radially inward from an inner surface of the stator body 14. Each tooth 16 includes a body portion 20 that extends radially and a crown portion 24 formed at a distal end of the body portion 20. A rotor (not shown) is supported for rotation with respect to the stator 10. The body portion 20, the crown portion 24, and the inner surface of the stator body 14 together define slots 60a and 60b between adjacent teeth 16.

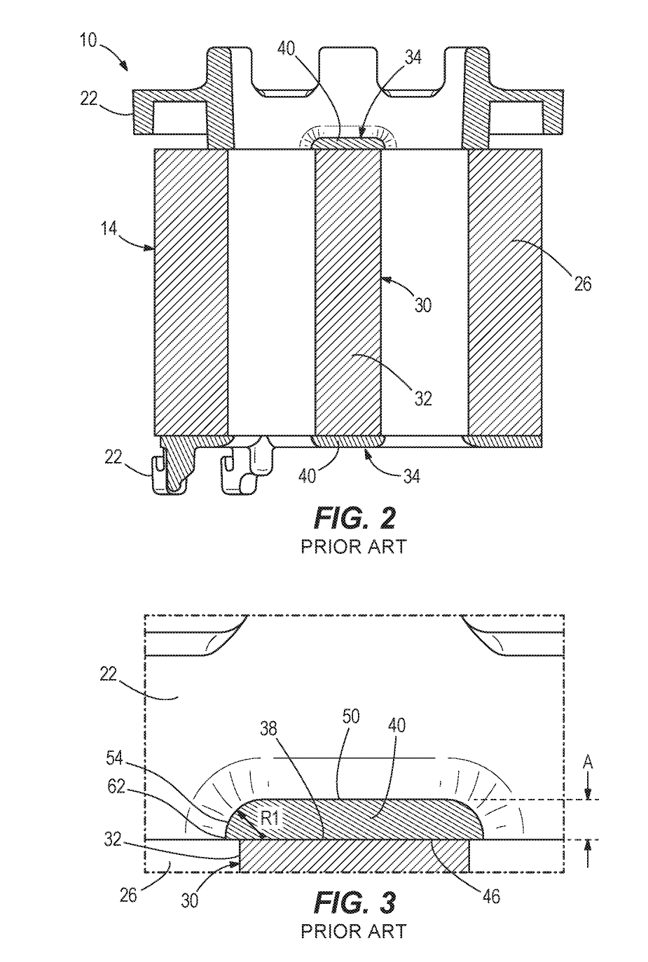

With reference to FIG. 2, the stator 10 further includes a stator core 26 sandwiched between a pair of insulating end caps 22 formed from an insulating material, such as plastic. In other embodiments (not shown), a single insulative member can be molded to the stator core 26 in lieu of the end caps 22. The stator core 26 includes inwardly protruding core tooth portions 30, and the end caps 22 include corresponding inwardly protruding end cap tooth portions 34. Together, the core tooth portions 30 and the end cap tooth portions 34 form the teeth 16. Each core tooth portion 30 includes a core tooth body portion 32 corresponding to the body portion 20 of each tooth 16 (FIG. 1). Likewise, each end cap tooth portion 34 includes an end cap tooth body portion 40 corresponding to the body portion 20 of each tooth 16.

FIG. 3 is a detail view illustrating a cross section of the tooth body portion 20 where the end cap 22 contacts an end of the stator core 26. Specifically, the core tooth body portion 32 includes a substantially flat core outer surface 38 that rests against a corresponding substantially flat end cap inner surface 46 of the end cap tooth body portion 40. The end cap tooth body portion 40 further includes a substantially flat end cap outer surface 50 located opposite the end cap inner surface 46 of the end cap tooth body portion 40. A rounded edge 54 having a radius of curvature R1 connects the end cap inner and outer surfaces 46 and 50 on each side of the end cap tooth body portion 40. The end cap tooth body portion 40 includes a thickness A measured between the end cap inner and outer surfaces 46, 50. The end cap inner surface 46 is also slightly wider than the core outer surface 38, so that an overlap 62 occurs on each side as shown in FIG. 3.

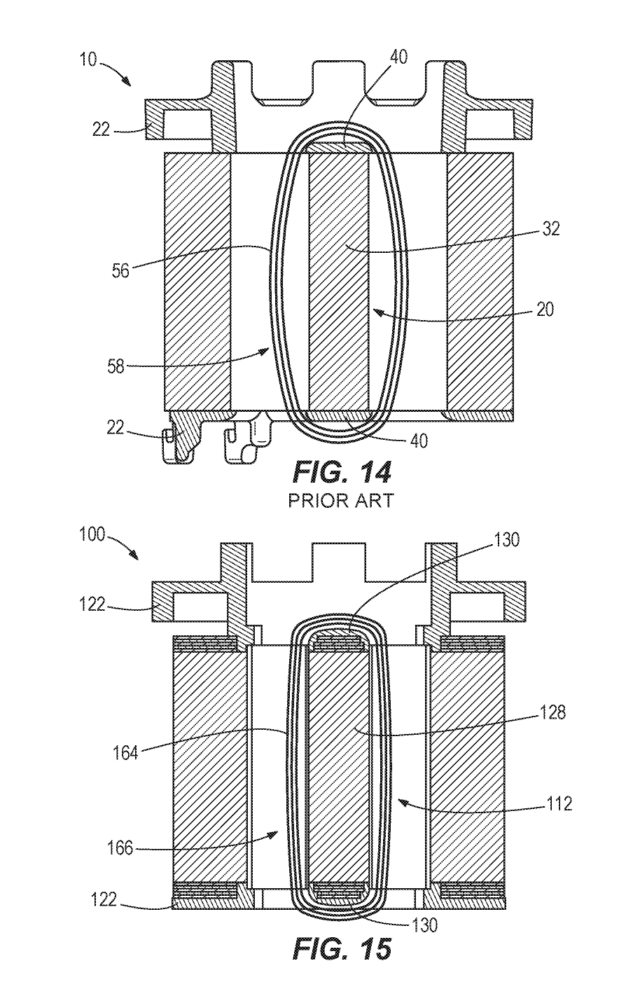

Referring to FIG. 14, wires 56 are wound around each tooth body portion 20 within the slots 60a and 60b to define coils or windings 58 that cooperate with the teeth 16 to define stator poles. During motor operation, electrical current flows through these windings 58 and produces heat. As will be discussed further below, the substantially flat end cap outer surface 50 and the relatively small radius of curvature R1 of the rounded edges 54 can cause the windings 58 to bow-out about the center of the tooth body portion 20 in the prior art stator 10. The overlap 62 can further exacerbate the bowing-out of the windings 58. Longer lengths of wires 56 may be required to account for the bowing-out of the windings 58, which increases the coil resistance in the windings 58 and can cause unwanted excess heat generation during operation.

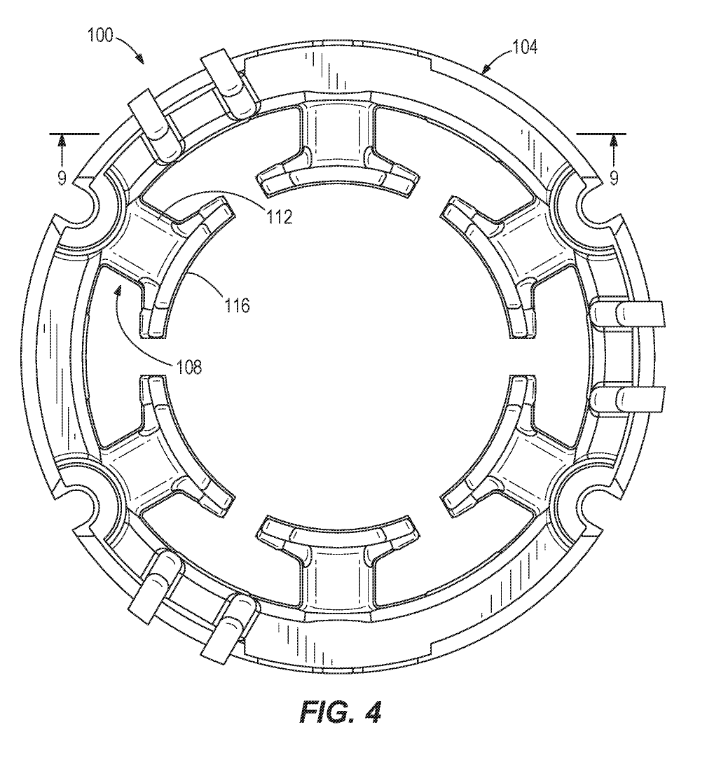

FIG. 4 illustrates an end view of a stator 100 for an electric motor according to one embodiment of the invention. The stator 100 includes a substantially cylindrical stator body 104 and inwardly protruding teeth 108 extending radially inward from an inner surface of the stator body 104. In the illustrated embodiment, the stator 100 includes six teeth 108 spaced equally apart about the inner surface of the stator body 104. In other embodiments, the stator 100 may include fewer or more than six teeth 108. Each tooth 108 includes a tooth body portion 112 that extends radially and a tooth crown portion 116 formed at a distal end of the body portion 112. A rotor (not shown) is supported for rotation with respect to the stator 100.

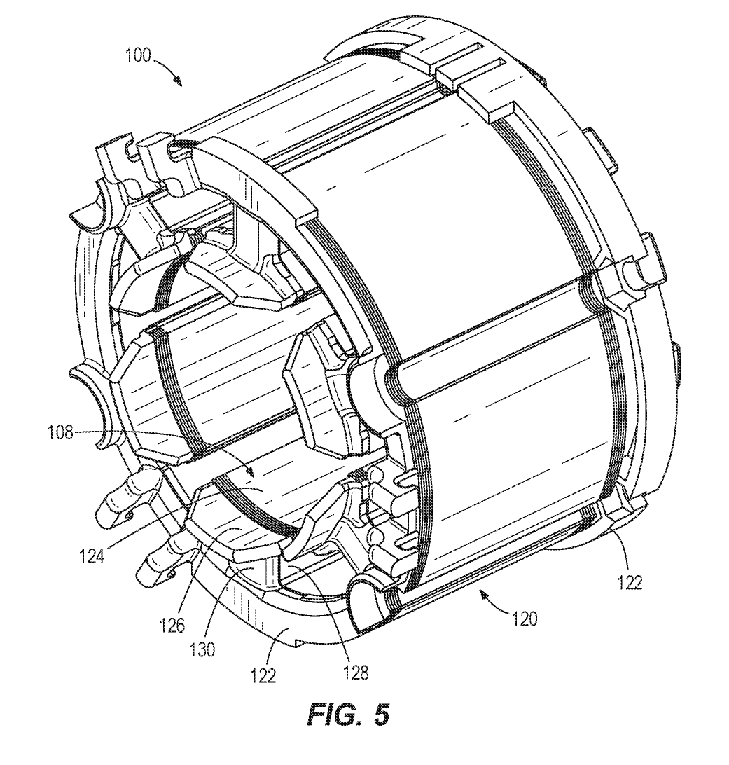

With reference to FIG. 5, the stator 100 further includes a stator core 120 sandwiched between a pair of insulating end caps 122 formed from an insulating material such as plastic. The stator core 120 includes inwardly protruding core tooth portions 124, and the end caps 122 include corresponding inwardly protruding end cap tooth portions 126. Together, the core tooth portions 124 and the end cap tooth portions 126 form the teeth 108. Each core tooth portion 124 includes a core tooth body portion 128 corresponding to the body portion 112 of each tooth 108. Likewise, each end cap tooth portion 126 includes an end cap tooth body portion 130 corresponding to the body portion 112 of each tooth 108.

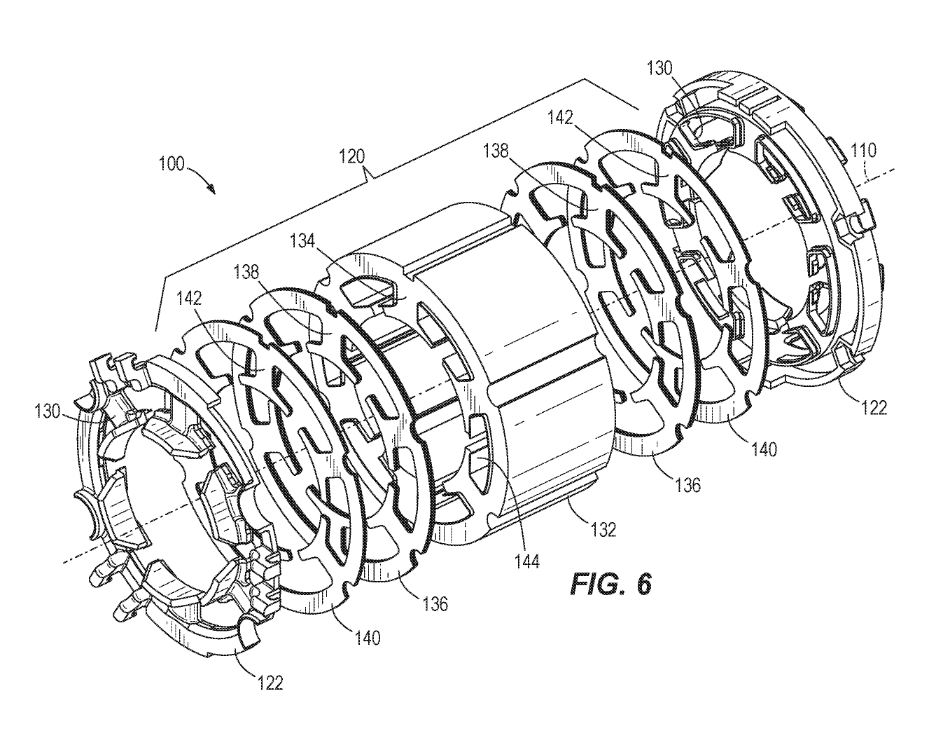

With reference to FIG. 6, the stator core 120 further includes stator core portions 132, 136, and 140 axially stacked to form the stator core 120. Specifically, a first core portion 132 forms a center of the stator core 120. A pair of second core portions 136 are axially stacked at each end of the stator core 120 adjacent the first core portion 132. A pair of third core portions 140 are axially stacked at each end of the stator core 120 adjacent the second core portions 136. The first, second, and third core portions 132, 136, and 140 are each provided with first, second, and third tooth body portions 134, 138, and 142, respectively, which together form the core tooth body portion 128.

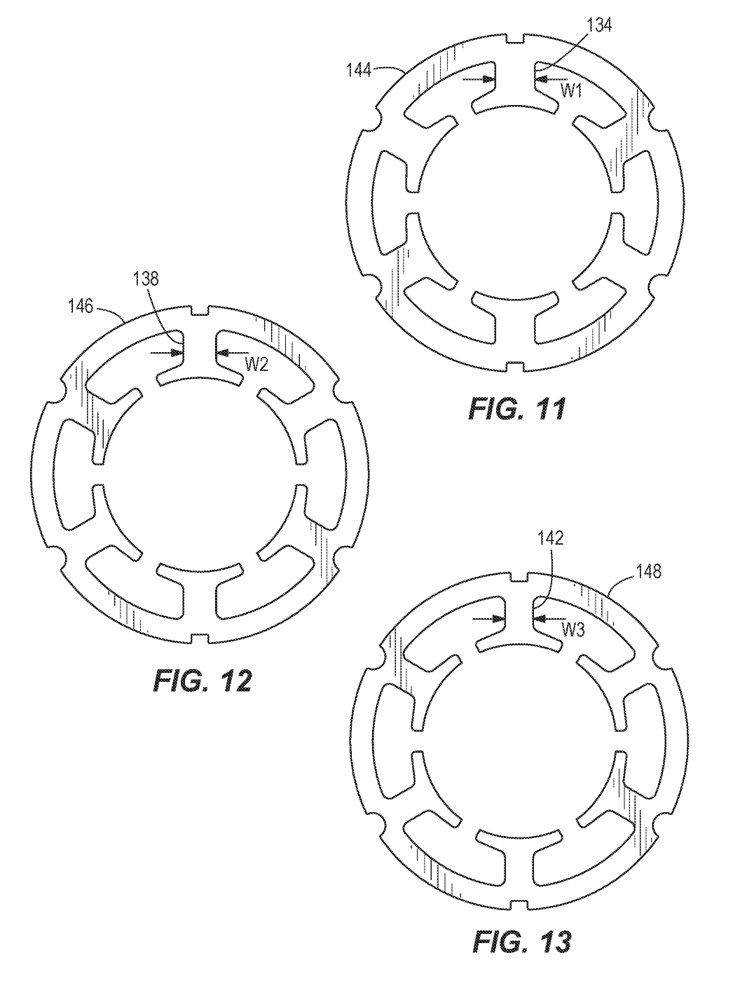

The first core portion 132 is formed by stacking a plurality of first laminations 144 (FIG. 11) along a longitudinal axis 110. Similarly, the second core portions 136 are formed by stacking a plurality of second laminations 146 (FIG. 12) along the axis 110, and the third core portions 140 are formed by stacking a plurality of third laminations 148 (FIG. 13) along the axis 110. The first, second, and third laminations 144, 146, and 148 may be formed from a magnetically conductive material such as steel.

As shown in FIGS. 11-13, the first tooth body portion 134 has a first tooth body portion width W1, the second tooth body portion 138 has a second tooth body portion width W2, and the third tooth body portion 142 has a third tooth body portion width W3. In the illustrated embodiment, the first tooth body portion width W1 is greater than the second core tooth body portion width W2. Likewise, the second tooth body portion width W2 is greater than the third tooth body portion width W3. In other embodiments, the stator core 120 may include additional core portions, where each successive tooth body portion width (e.g., fourth W4, fifth W5, etc.) is less than the preceding tooth body portion width. However, providing the stator 100 with only three core portions 132, 136, and 140 comprising the three laminations 144, 146, and 148 can minimize a number of stations on a stamping die required to manufacture the stator core 120.

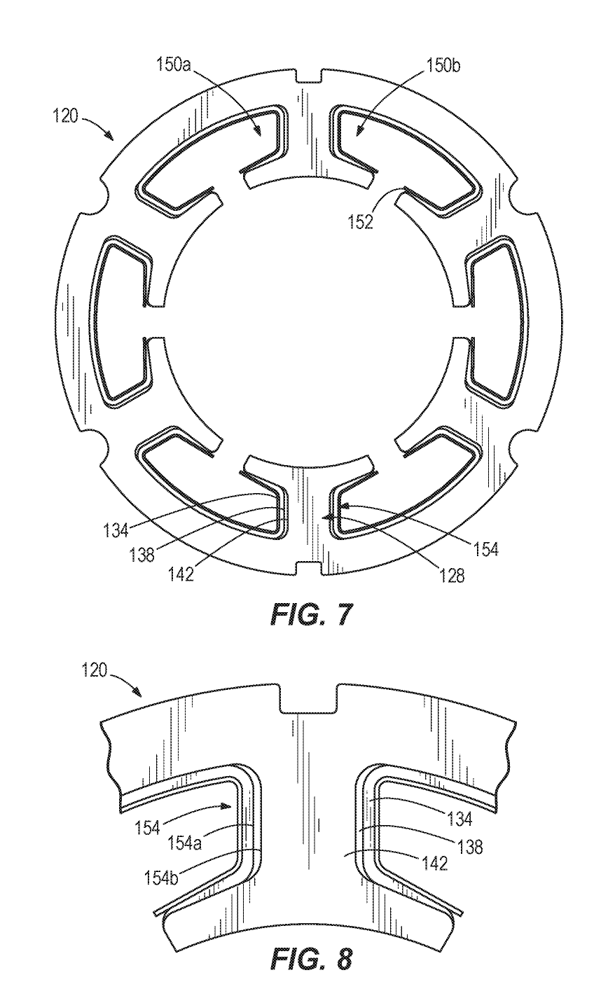

With reference to FIG. 7, the tooth body portion 112, the tooth crown portion 116, and the inner surface of the stator body 104 together define slots 150a and 150b defined between adjacent teeth 108. As will be discussed in more detail below, the slots 150a and 150b receive wires 164 (FIG. 15) that are wound around each tooth body portion 112 to define coils or windings 166 that cooperate with the teeth 108 to define stator poles. Each slot 150a and 150b also receives a sheet 152 of insulating material (e.g., paper) that is supported by the tooth body portion 112, the tooth crown portion 116, the inner surface of the stator body 104, and the end caps 122.

Referring to FIGS. 7 and 8, the first, second, and third tooth body portions 134, 138, and 142 together form steps 154 at the ends of the core tooth body portion 128. Specifically, a first step 154a (FIG. 8) is formed between the first tooth body portion 134 and the second tooth body portion 138, and a second step 154b is formed between the second tooth body portion 138 and the third tooth body portion 142. The stepped configuration at each end of the core tooth body portion 128 results in a progressive narrowing of the core tooth body portion 128 from W1 (FIG. 11) at the first tooth body portion 134, to W2 (FIG. 12) at the second tooth body portion 138, and finally to W3 (FIG. 13) at the third tooth body portion 142. In some embodiments, one or both ends of the core tooth body portion 128 includes additional steps formed by additional tooth body portions (e.g., fourth tooth body portion, fifth tooth body portion, etc.).

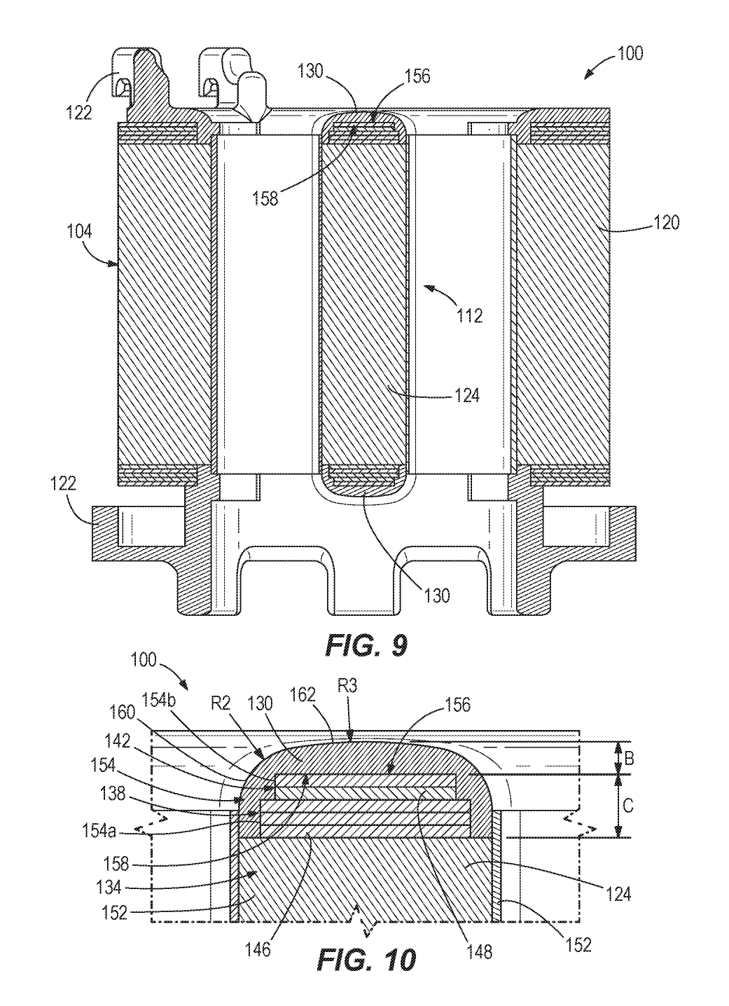

With reference to FIGS. 9 and 10, the steps 154 provide a stepped core outer surface 156 extending along each end of the core tooth body portion 128, which mates with a corresponding stepped end cap inner surface 158 of the end cap tooth body portion 130. FIG. 10 further illustrates a portion of the tooth body portion 112 where the end cap tooth portion 126 contacts the core tooth portion 124. The stepped end cap inner surface 158 permits the end cap tooth body portion 130 to overlap each of the second and third tooth body portions 138 and 142, so that the second and third tooth body portions 138 and 142 are encased between the end cap tooth body portion 130 and the first tooth body portion 134. The end cap tooth body portion 130 overlaps the second and third tooth body portions 138 and 142 by a distance C, measured between a furthest recessed portion of the stepped end cap inner surface 158 and an outer surface of the first tooth body portion 134.

The end cap tooth body portion 130 further includes a curved end cap outer surface 162, with radius of curvature R3 (e.g., 12.0 mm), located opposite the stepped end cap inner surface 158. A rounded edge 160 having a radius of curvature R2 joins the end cap inner and outer surfaces 158 and 162 together on each side of the end cap tooth body portion 130. In other embodiments, the edge 160 may alternatively be a beveled edge having a linear extent connecting the inner and outer surfaces 158, 162. In further embodiments, a geometry of the end cap may differ depending upon the number of windings used in the specific motor. For example, in motors having 40 turns of 0.6 mm diameter wire the end cap may have one profile or geometry, whereas in motors having 13 turns of 1.1 mm diameter wire the end cap may have another profile or geometry.

The end cap tooth body portion 130 includes a thickness B measured between an outermost point of the curved end cap outer surface 162 and a furthest recessed portion of the stepped end cap inner surface 158, as illustrated in FIG. 10. The steps 154 formed by the first, second, and third tooth body portions 134, 138, and 142 allow for a larger radius of curvature R2 compared to the radius of curvature R1 discussed above with respect to the stator 10, while maintaining the same or achieving a smaller thickness B in comparison to the thickness A discussed above. For example, in one embodiment, the thickness B is 0.9 mm, while the thickness A is 1.2 mm or greater, such that the thickness B is 25% less than the thickness A. In this regard, the steps 154 allow for a larger radius of curvature R2 compared to R1 while minimizing the amount of material needed to form the end cap tooth body portion 130. In one embodiment, the radius of curvature R2 of the curved end cap outer surface 162 is approximately 1.75 mm. Conversely, the radius of curvature R1 of the stator 10 is 1.2 mm or less. In this regard, the steps 154 permit a radius of curvature R2 that is approximately 45% larger than the radius of curvature R1.

FIG. 10 illustrates the second core portion 136 having three second laminations 146, and the third core portion 140 having two third laminations 148. In other embodiments, additional core portions forming additional steps, additional second and/or third laminations, or laminations having increased thickness may be provided to further increase the radius of curvature R2 of the curved end cap outer surface 162. In such embodiments, the endcap geometry may be varied accordingly to overlap further over the stator core, allowing for more steel (forming the stator core) in the design. In further embodiments, the stator core may be provided with fewer core portions (e.g., only a first core portion and a second core portion), so that only one step is formed at each end of the core tooth body portion 128.

With continued reference to FIG. 10, the rounded edge 160 of the end cap tooth body portion 130 is substantially flush with the core tooth body portion 128 on each side. This permits the sheet 152 to extend outward beyond the outer edge of the first tooth body portion 134, so that the sheet 152 partially overlaps the rounded edge 160 on each side of the tooth body portion 112. Increasing the overlap of the insulating sheet 152 permits higher voltage applications for the stator 100.

With reference to FIG. 15, as discussed above, the wires 164 are wound around each tooth body portion 112 within the slots 150a and 150b to define coils or windings 166 that cooperate with the teeth 108 to define stator poles. During motor operation, electrical current flows through these windings 166 and produces heat. The larger radius of curvature R2 of the rounded edges 160, and curvature of the curved end cap outer surface 162 having radius of curvature R3, both provide for a more gradual bend of the windings 166 as the windings 166 pass around the end cap tooth body portion 130. This permits the windings 166 to be wound more tightly about the tooth body portion 112, and prevents the windings 166 from bowing-out about the center of the tooth body portion 112 as can occur in the prior art stator 10 (FIG. 14). By wrapping the windings 166 more tightly, and by preventing the windings from bowing-out, shorter lengths of wires 164 are required as compared to the wires 56 of the stator 10 (FIG. 14), which decreases the coil resistance in the windings 166 and reduces the amount of heat generated during operation.

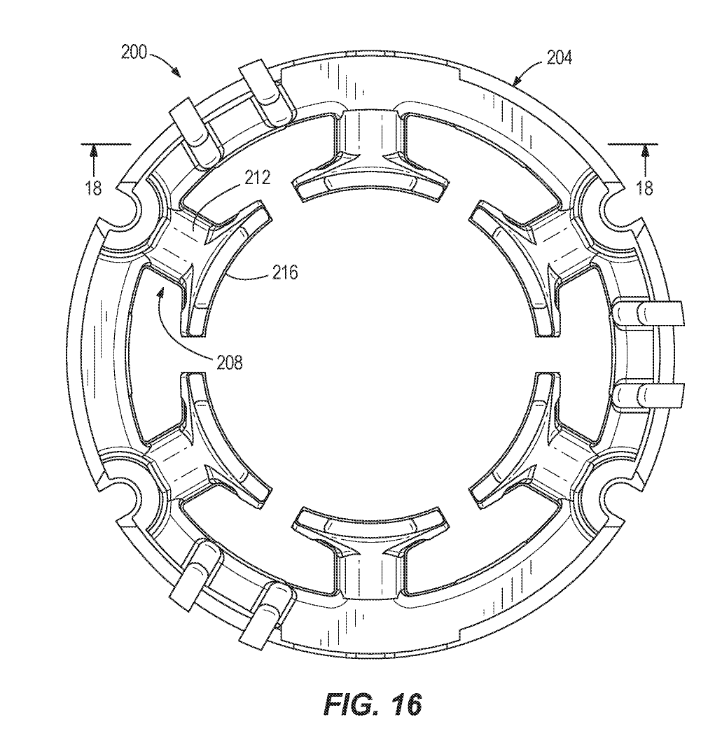

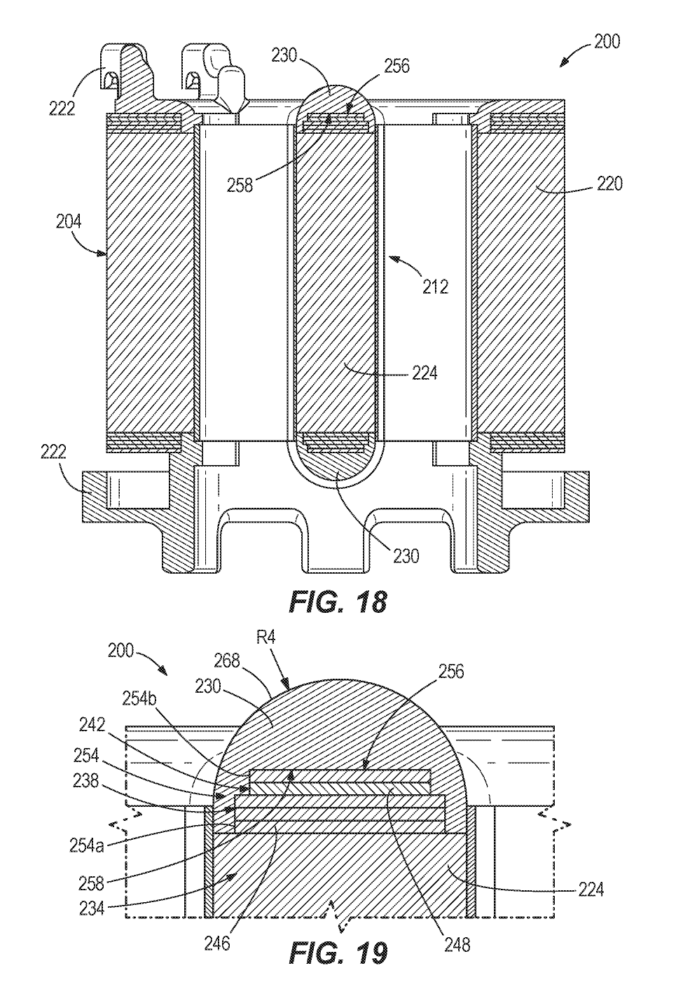

FIGS. 16-19 illustrate a stator 200 for an electric motor according to another embodiment of invention. This embodiment employs much of the same structure and has many of the same properties as the stator 100 described above in connection with FIGS. 4-13 and 15. Accordingly, the following description focuses primarily upon the structure and features that are different than the embodiments described above in connection with FIGS. 4-13 and 15. Features and elements in the embodiment of FIGS. 16-19 corresponding to features and elements in the embodiments described above in connection with FIGS. 4-13 and 15 are numbered in the 200 series of reference numbers.

With reference to FIG. 16, the stator 200 includes a substantially cylindrical stator body 204 and a plurality of inwardly protruding teeth 208 extending radially inward from an inner surface of the stator body 204. In the illustrated embodiment, the stator 200 includes six teeth 208 spaced equally apart about the inner surface of the stator body 204. In other embodiments, the stator 200 may include fewer or more than six teeth 208. Each tooth 208 includes a tooth body portion 212 that extends radially and a tooth crown portion 216 formed at a distal end of the body portion 212. A rotor (not shown) is supported for rotation with respect to the stator 200.

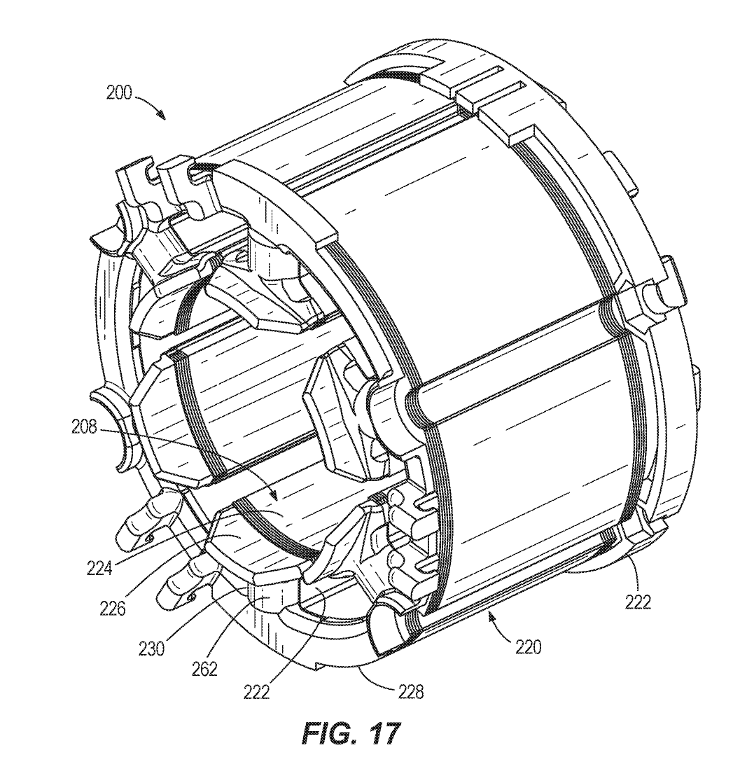

With reference to FIG. 17, the stator 200 further includes a stator core 220 sandwiched between a pair of insulating end caps 222 formed from an insulating material such as plastic. The stator core 220 includes inwardly protruding core tooth portions 224, and the end caps 222 include corresponding inwardly protruding end cap tooth portions 226. Together, the core tooth portions 224 and the end cap tooth portions 226 form the teeth 208. Each core tooth portion 224 includes a core tooth body portion 228 corresponding to the body portion 212 of each tooth 208. Likewise, each end cap tooth portion 126 includes an end cap tooth body portion 230 corresponding to the body portion 212 of each tooth 208.

As illustrated in FIGS. 17-19, the end cap tooth body portion 230 includes a stepped end cap inner surface 258 and a curved end cap outer surface 268. Unlike the end cap tooth body portion 130 of the stator 100 discussed above, the end cap tooth body portion 230 does not include a rounded edge connecting the stepped end cap inner surface 258 and the curved end cap outer surface 268 on each side. Instead, the curved end cap outer surface 268 has a constant radius of curvature R4, so that the curved end cap outer surface 268 extends all the way from a first side of the stepped end cap inner surface 258 to a second side of the stepped end cap inner surface 258. The constant radius of curvature R4 of the curved end cap outer surface 268 provides for a maximum turning radius of the windings (not shown) as the windings pass around the end cap tooth body portion 230. In this way, the constant radius of curvature R4 minimizes the tendency of the windings to bow-out.

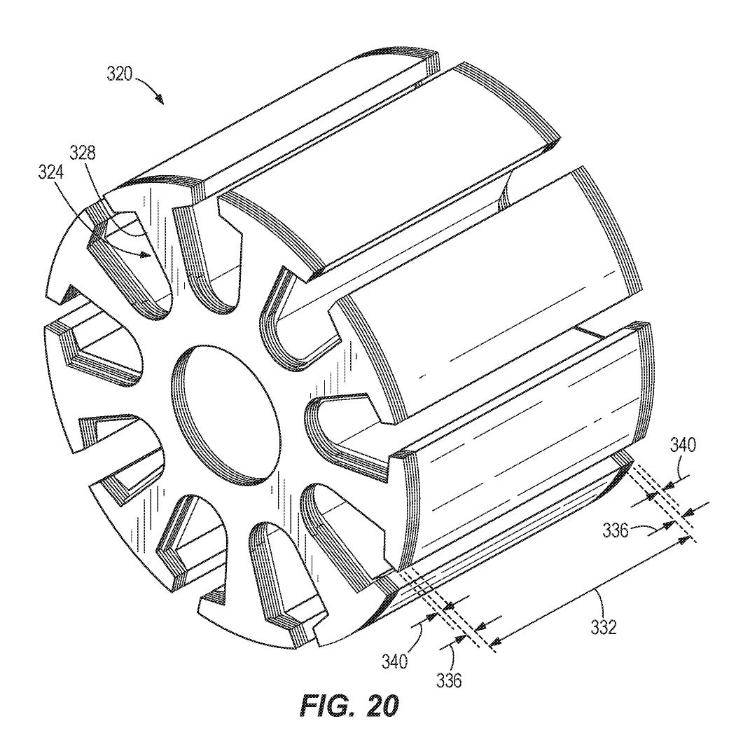

FIGS. 20-22 illustrate a stator core 320 for an electric motor according to another embodiment of invention. This embodiment employs much of the same structure and has many of the same properties as the stator cores 120 and 220 described above in connection with FIGS. 4-13 and 15, and with FIGS. 16-19, respectively. Accordingly, the following description focuses primarily upon the structure and features that are different than the embodiments described above in connection with FIGS. 4-13 and 15, and with FIGS. 16-19. Features and elements in the embodiment of FIGS. 20-22 corresponding to features and elements in the embodiments described above in connection with FIGS. 4-13 and 15, and with FIGS. 16-19, are numbered in the 300 series of reference numbers.

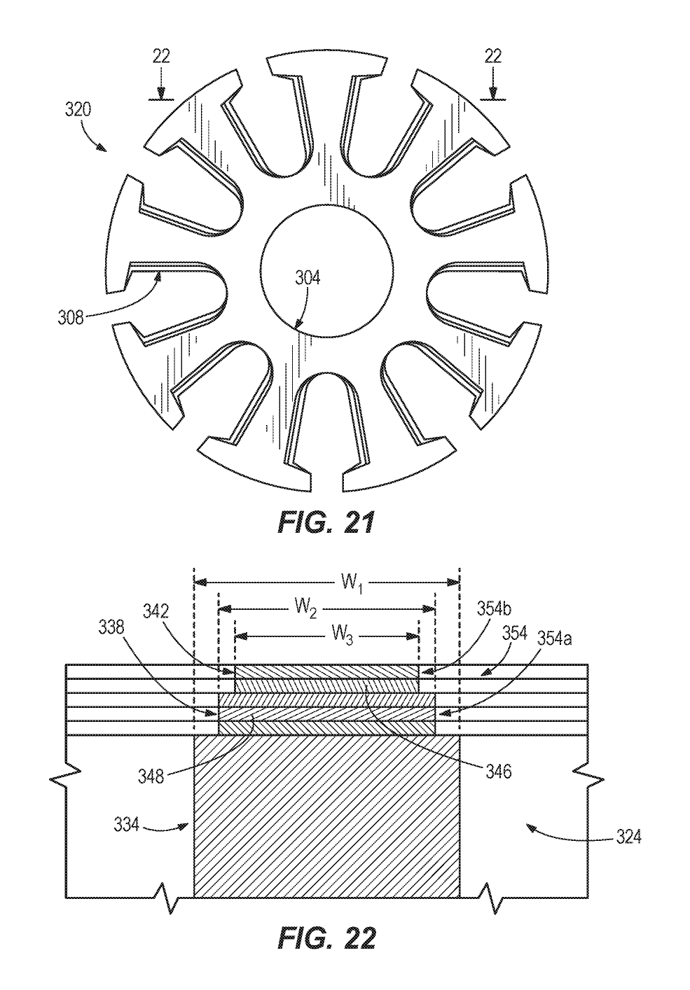

With reference to FIGS. 20 and 21, the stator core 320 is configured for use with a stator (not shown) similar to the stators 100, 200 described above, except that the stator associated with stator core 320 is an inner stator (i.e. a stationary rotor). As such, the stator associated with the stator core 320 includes outwardly projecting teeth. The stator core 320 includes a core body portion 304 formed in a central region of the stator core 320, and core tooth portions 324 extending outwardly in a radial direction from the core body portion 304. A rotor (not shown) is supported about the stator core 320 for rotation about the stator.

The stator core 320 further includes stator core portions 332, 336, and 340 axially stacked to form the stator core 320. Specifically, a first core portion 332 forms a center of the stator core 320. A pair of second core portions 336 are axially stacked at each end of the stator core 320 adjacent the first core portion 332. A pair of third core portions 340 are axially stacked at each end of the stator core 320 adjacent the second core portions 336. Each core tooth portion 324 includes a core tooth body portion 328 corresponding to a body portion of each tooth. The first, second, and third core portions 332, 336, and 340 are each provided with first, second, and third tooth body portions 334, 338, and 342, respectively (FIG. 22), which together form the core tooth body portion 128.

With reference to FIG. 22, the first, second, and third tooth body portions 334, 338, and 342 together form steps 354 at the ends of the core tooth body portion 328. Specifically, a first step 354a is formed between the first tooth body portion 334 and the second tooth body portion 338, and a second step 354b is formed between the second tooth body portion 338 and the third tooth body portion 342. The stepped configuration at each end of the core tooth body portion 328 results in a progressive narrowing of the core tooth body portion 328 from a first width W1 at the first tooth body portion 334, to a second width W2 at the second tooth body portion 338, and finally to a third width W3 at the third tooth body portion 342. In some embodiments, one or both ends of the core tooth body portion 328 includes additional steps formed by additional tooth body portions (e.g., fourth tooth body portion, fifth tooth body portion, etc.). An end cap or insulative member (not shown) can include a stepped recess that receives the steps 354 when the insulative member is coupled to the stator core 320.

Although the application has been described in detail with reference to certain preferred embodiments, variations and modifications exist within the scope and spirit of one or more independent aspects of the application as described.

What is claimed is:

1. An electric motor comprising:
a stator including a stator core and an insulative member coupled to the stator core, the stator core and the insulative member cooperating to define a body portion and a plurality of teeth projecting radially from the body portion, each tooth having a tooth crown portion at a radially distal end and a tooth body portion extending between the body portion and the crown portion;
wherein the stator core comprises
a first core portion having first tooth body portions that partially define the tooth body portions; and
a second core portion stacked against the first core portion at an axial end of the stator core, the second core portion having second tooth body portions that partially define the tooth body portions;
wherein the first tooth body portion of at least one tooth body portion has a first width, and the second tooth body portion of the at least one tooth body portion has a second width that is less than the first width.

2. The electric motor of claim 1, further comprising a third core portion stacked against the second core portion at the axial end of the stator core, the third core portion having third tooth body portions that partially define the tooth body portions, wherein the third tooth body portion of the at least one body portion has a third width that is less than the second width.

3. The electric motor of claim 1, wherein the first and second core portions together define steps on the at least one tooth body portion at the axial end of the stator core.

4. The electric motor of claim 3, wherein the insulative member includes a stepped recess that receives the steps.

5. The electric motor of claim 1, wherein:
the axial end of the stator core is a first axial end, and the stator core includes a second axial end opposite the first axial end; and
second core portions are stacked against the first core portion at each of the first and second axial ends.

6. The electric motor of claim 5, wherein third core portions are stacked against the second core portions at each of the first and second axial ends.

7. The electric motor of claim 5, wherein the insulative member includes a first end cap coupled to the stator core at the first axial end, and a second end cap coupled to the stator core at the second axial end.

8. The electric motor of claim 1, wherein the first tooth body portion of each of the tooth body portions has a first width, and the second tooth body portion of each of the tooth body portions has a second width that is less than the first width.

9. An electric motor comprising:
a stator including an annular stator core and an insulative member coupled to the stator core, the stator core and the insulative member together defining a body portion and a plurality of teeth projecting radially from the body portion, each tooth having a tooth crown portion at a radially distal end and a tooth body portion extending between the body portion and the crown portion;
wherein steps are formed on at least one tooth body portion at an axial end of the stator core.

10. The electric motor of claim 9, further comprising a stepped recess formed in the insulative member, wherein the stepped recess is configured to receive the steps of the at least one tooth body portion when the insulative member is coupled to the axial end of the stator core.

11. The electric motor of claim 9, wherein:
the axial end of the stator core is a first axial end, and the stator core includes a second axial end opposite the first axial end; and
steps are formed on the at least one tooth body portion at each of the first and second axial ends.

12. The electric motor of claim 9, wherein the steps comprise 3 or more steps.

13. The electric motor of claim 11, wherein the steps comprise 3 or more steps formed at each of the first and second axial ends.

14. The electric motor of claim 11, wherein the insulative member includes a first end cap coupled to the stator core at the first axial end, and a second end cap coupled to the stator core at the second axial end.

15. The electric motor of claim 14, wherein the first end cap includes a first stepped recess that receives the steps formed at the first axial end, and the second end cap includes a second stepped recess that receives the steps formed at the second axial end.

16. The electric motor of claim 9, wherein steps are formed on each of the tooth body portions at the axial end of the stator core.

17. An electric motor comprising:
a stator including an annular stator core and an insulative body coupled to the stator core, the stator including a body portion and a plurality of teeth projecting inwardly from the body portion, each tooth having a tooth crown portion at a radially distal end and a tooth body portion extending between the body portion and the crown portion;
wherein the stator core includes core tooth body portions, and the insulative member includes end cap tooth body portions contacting the core tooth body portions;
wherein the end cap tooth body portions include end cap inner surfaces that mate with respective core tooth body portions, and end cap outer surfaces located opposite the end cap inner surfaces;
wherein the end cap outer surface of at least one end cap tooth body portion comprises a curved surface having a constant radius of curvature.

18. The electric motor of claim 17, wherein each of the end cap outer surfaces comprises the curved surface having the constant radius of curvature.

19. The power tool of claim 17, wherein at least one core tooth body portion includes steps formed at an axial end.

20. The power tool of claim 17, wherein each of the core tooth body portions includes steps formed at an axial end.
